(19) United States
(12) Patent Application Publication
(10) Pub. No.: US 2015/0035650 A1
(43) Pub. Date: Feb. 5, 2015

(54) System and Method Employing Near Field Communication and QR Code Technology to Access and Manage Server-Side Personal and Business Property Security Status Accounts

(71) Applicant: Marshall G. Lind, San Jose, CA (US)

(72) Inventor: Marshall G. Lind, San Jose, CA (US)

(73) Assignee: Marshall G. Lind, San Jose, CA (US)

(21) Appl. No.: 13/956,577

(22) Filed: Aug. 1, 2013

(51) Int. Cl. G06K 7/10; H04L 29/06; H04B 5/00

(52) U.S. Cl. CPC G06K 7/10237; H04B 5/0056; H04L 63/126
USPC 340/10.1

(57) ABSTRACT

System and method for remotely viewing, managing and/or verifying online security status and ownership records of registered personal and business properties on a host server. The system is engaged using wireless or wired Internet-connected transceiver devices capable of interfacing with the host server by hyperlinking to a property's unique Internet Protocol (IP) address upon interrogation of encoded Near Field Communication (NFC) tag(s) or quick read (QR) code(s) target objects. These account-matching items are affixed to said property and also featured on the owner/registrar's smartcard ID along with the printed IP address registration number for manual Internet browser access. The system encourages public device interrogation for online viewing of property security status information, while a secure method of authentication restricts all other property account access to owner/registrar and law enforcement.

### BACKGROUND OF INVENTION

Inscribing valuable objects with owner name, social security and/or telephone number is no longer an appropriate property identification practice in the modern world, with a transient population subjected to identity theft and law enforcement lacking the resources to follow up on stolen property reports. But finding another solution to effective property identification has proved elusive. One such example is local government sponsored bicycle registration programs, which are being phased out for proving to be too costly and ineffective, with greater numbers of stolen bikes being sold online and/or outside local jurisdictions.

While people and businesses have come to rely on insurance companies for property replacement solutions, property assigned a high intangible personal value such as bicycles, instruments, pets and electronic items containing priceless content continue to drive the demand for an effective, sophisticated property registration security system. A few privately organized bicycle registration programs continue to use bike frame stickers as a visual aid to help law enforcement identify stolen registered bikes. But stickers alone are susceptible to being defaced, scraped off or painted over and they fail to inform on-site parties of a property's current security status.

Radio frequency identification (RFID) offers a more sophisticated method for identifying and/or tracking property. Developed by Los Alamos National Laboratory in the '70s, the system consists of transceivers capable of reading active or passive RFID tag transponders assigned to a target. An active RFID tag is battery-powered for long-distance signal broadcasting, whereas passive tags receive power from an interrogating transceiver reading in close proximity. By the mid-80s passive RFID technology found its way into a keyless card entry identification system and a retail inventory tagging security system, while active RFID made was first used for tracking and identifying rolling railroad inventory and fleet vehicles and for paying highway tolls remotely.

In time the development of lower frequency (120-150 kHz) miniature RFID transponders and integrated circuit (IC) chips opened up portable RFID applications, most famously the pet/owner identification system. The passive RFID chips and tags are injected or attached to animals to be scanned by handheld RFID readers when livestock is stolen or a pet is lost or abandoned Similar passive and active RFID tagging applications have been developed to identify owners of lost or stolen personal properties, but these systems share many shortcomings. The RFID transponders/transceiver systems are calibrated to read at different frequencies to drive sales of proprietary RFID readers. In addition to frequency incompatibilities, readers are designed as single function devices, so few people outside professionals can justify purchasing one. Then there's the impracticality of carrying another specialized tool. A less obvious disadvantage is the system's relatively high frequency, which can pose a security risk by broadcasting personal information over greater distances.

By contrast, Near Field Communication (NFC) is a relative newcomer and subset of RFID technology, operating at a standardized 13.56 MHz to provide a shorter, secure “contactless” communication range of less than 20 cm. And, because NFC's operational specifications were established by consensus in 2006 after cell phone manufacturers Nokia, Sony and Philips established the NFC Forum, this standardized operating frequency has encouraged an increasing number of manufacturers to equip their smartphones with NFC hardware and software. The passive NFC tag consists of a capacitor, antennae and microchip capable of storing a limited command string. When the NFC function of an NFC-equipped device is turned on and held over a targeted tag, the tag's antennae receives the signal, powers up the capacitor and activates the microchip, which then transmits the command action or information data encoded within it back to the interrogating device using the NDEF data exchange format.

This mobile phone technology, combined with production of smaller, more effective and inexpensive NFC dry and wet (sticker) tags and NFC cards has encouraged both businesses and consumers to explore new NFC tag applications, although development has concentrated almost exclusively on billing, purchasing, club affiliation, medical, marketing and promotional programs. There are known property loss and theft passive RFID systems employing readers paired with property NFC tags, but they rely on a single target technology platform and property tagging is linked to a home, business or mobile-based proximity alarm system, which signals when a RFID-tagged item, pet or person has left or is in a coverage area. Other systems involve writing contact information or an identification code directly onto an IC chip, passive NFC tag or card, but all fail to provide the interrogator with an immediate visual of security status information.

As with all RFID transponders, a significant benefit of the NFC tag is it does not rely on line-of-sight readability. The passive tag continues to function even when imbedded, hidden from view, covered up or painted over. The NFC tag's one notable weakness is its performance around metal, which interferes with antenna reception. While encasing a tag within metal is not an option, it can be read on a metal surface if isolated with a ferrite base layer.

Another powerful public communication tool, but one relying on line-of-sight readability, is the QR code. The availability of downloadable QR Code phone applications designed to read the proliferation of printed QR codes makes this technology a viable hyperlink alternative when interrogating devices lack NFC technology. The QR Code, a matrix type barcode first introduced by the Japanese automotive industry in 1994 for tracking vehicle manufacturing, has since been used in a variety of applications, achieving broad public appeal after QR code scanner/reader applications were introduced on smartphone platforms in 2010. Printed QR codes are most often encoded with domain addresses to hyperlink consumers directly to targeted Websites in virtually every industry. They allow the viewer to get more detailed information, to capitalize on coupons, specials and discounts, and to make purchases, get directions, view menus, etc.

For use in security situations, however, the QR code's weakness remains its surface-pattern susceptibility to accidental or intentional defacement or removal, since hyperlink activation requires clean, line-of-sight readability. If employed without identifying commercial markings, the QR code sticker does have the advantage of not revealing its security application to an uninformed thief.

### SUMMARY OF INVENTION

The present security status system invention consists of three integral components: 1) multiple property target objects, 2) reader interface devices and 3) a centralized host server essential to registering, managing, viewing and verifying owner and property account information. The most distinguishing feature of this invention compared to other personal and business property security systems is the employment of multiple target object technologies and visual account indicators to accommodate the plethora of Internet interface tools used by property registrar/owners and interrogators for remotely viewing a property's current Online security status. Another distinguishing feature of the System is the assignment of a single unique identifying Internet Protocol (IP) account number to each set of property target objects and smartcard ID supplied to a property registrar/owner, as opposed to a multi-step reference number method used by other property status/identification systems. This simplifies registration and security status activation and look-up, avoids procedural mistakes and enables server-side management and update control, while eliminating the need for registrar target object coding or proprietary software downloads.

Property registration is initiated and authenticated by a registrar, who has either acquired a property with system target objects, or is furnished with property kits containing account-matching passive Near Field Communication (NFC) and Quick Read (QR) code property target objects and a smartcard ID featuring passive NFC and QR Code technology and a visible alphanumeric account number. System target objects may be permanently integrated, enclosed within or attached to a property.

Once the tamper-resistant property target objects are in place in a reader-accessible area, the registrar accesses the objects' unique IP address on the host server using their own internet-connected wireless or wired interface device in the same manner as any party interested in determining a property's security status, by automatically hyperlinking to the IP address encoded in the property's NFC tag or QR code sticker or by performing like operations through the smartcard ID. Access is also available by manually entering the printed account number on the smartcard into an Internet browser's domain name address window.

Only by submitting the correct registrar-selected authentication metrics on the IP address page is access granted to the registrar's Master Account Directory, which contains registrar information and hyperlinks to the Property Account directory of each unique IP account number assigned to said registrar. Before the property can be officially registered, the registrar/owner must enter all property and owner details relating to the property to which target objects are affixed.

The owner next activates the property's current security status announcement, which automatically overwrites the “Account Activation” page initially displayed at the property's unique IP address with a property Security Status Page publicly revealing the property as “Secure”, “Stolen”, “Lost” or “For Sale”, or other status following the spirit of this invention, including “Account Deactivated”.

While the registration process is largely automatic, with relevant entries auto-filled on related form files for registrar convenience, the centralized network server's operating entity is ultimately responsible for creating user interface and database file system architecture. This includes assigning unique IP addresses to account directories, managing and overseeing all registrar/owner and property directory account records, ensuring reliable system communications, and creating theft, property inventory and sales statistics, reports and/or maps.

The internet-connected devices used in this Security System are independently owned and operated and function only as transceiver interfaces between system target objects and the host server, with IP address hyperlink connections carried out through publicly available technologies. NFC-equipped mobile devices are common and QR code reader software can be downloaded to any mobile platform. Only computer-connected NFC readers require specialized software.

For the public or law enforcement to ascertain the security status of a property item, the target object is either interrogated or the QR code account number manually entered into a host server's home page where indicated. To automatically hyperlink to the property's unique IP address encoded in the locked (read-only) NFC tag, an interface device's NFC function must be turned on and Internet service engaged before holding the device within 20 cm of the tag. Owners of mobile devices not NFC equipped can instead automatically hyperlink to the IP address by opening the QR code reader application and scanning the property's printed QR code sticker using the device's camera.

Regardless the Security Status Page displayed, the account number is prominently visible along with the owner's name, contact phone number and general residency location to help establish how far the property has moved. The Page also features a secure authentication section for granting property owner and law enforcement account access functions. If the interrogator believes a property is in the process of being stolen, a phone call will quickly determine the plausibility of any story. A name match between the Security Page listing and the one printed by the owner on the smartcard ID will also verify ownership claims, or, if an internet connection is unavailable the smartcard's printed account number can be compared with one printed on the property's target objects. The registrar has the authority to add family and personal accounts and correct, update or edit most property and owner information, except for those involving fixed content.

Because mobile phone imaging is widely practiced, this invention also includes a provision promoting the storage of a virtual representation of the smartcard as well, as card front and back photographic images along with an offline record of the property's Security Status page.

The present invention as described is framed in the referenced context of present day technologies and is not intended to exclude any improved or altered NFC or QR code applications of the future. There may also be instances where some features of the present invention may be employed without the use of other features for spatial, logistical or obsolescence considerations. It is appropriate that this invention's claims and description be interpreted in a manner acknowledging the novelty of the property security status system while accounting for the fluidity of evolving technologies.

### BRIEF DESCRIPTION OF DRAWINGS

FIG. 1 shows an overview of security system components and their relationships to one another.

FIG. 2 is a flowchart diagramming the property registration process and server database functions.

FIG. 3 is a flowchart diagramming subsequent registrar/owner property account management options.

FIG. 4 illustrates passive NFC tag components and activation method as it relates to the invention.

FIG. 5 provides example of the printed QR code sticker as it relates to the invention.

FIG. 6 illustrates front and back of smartcard ID with its array of property account-matching features.

FIG. 7 shows wired and wireless devices interfacing with target objects, smartcard ID and host server.

### DETAILED DESCRIPTION OF THE INVENTION

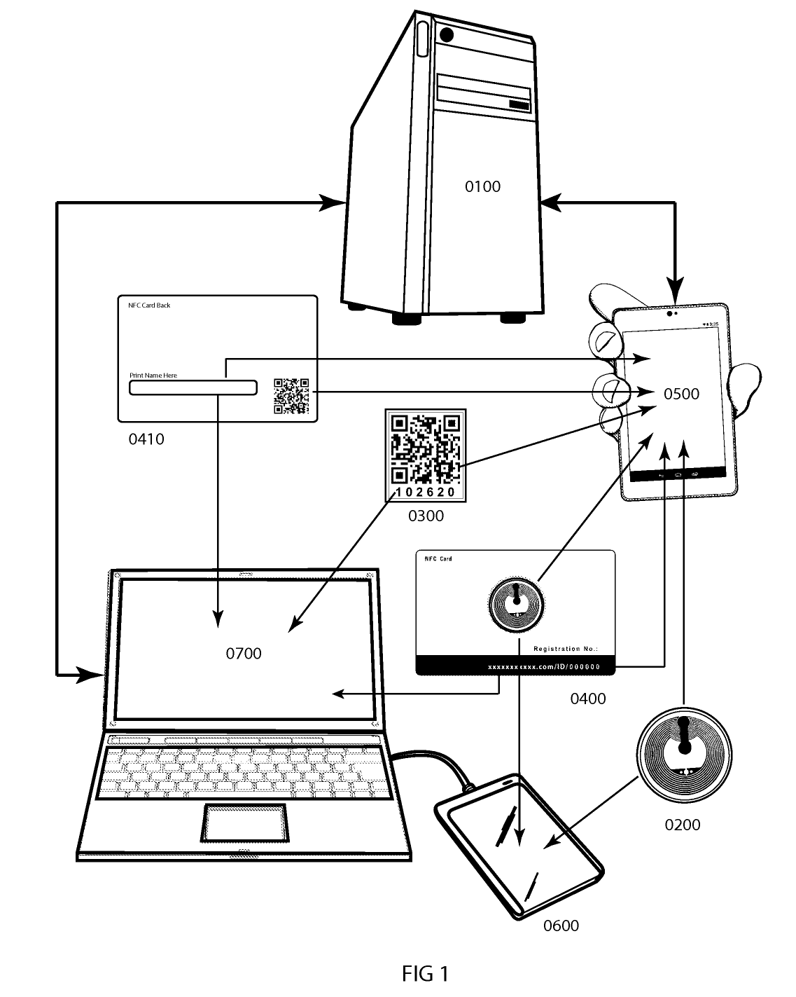

FIG. 1 Illustrates an overview of the physical technological components of this invention, a personal and business property security status system and method designed to deter theft and assist in the return of stolen or lost property items by providing public online viewing of owner-activated property security status announcements and owner information. The system features a host server 0100; target objects consisting of a passive Near Field Communication (NFC) tag 0200, Quick Read (QR) code sticker 0300 and smartcard ID front 0400 and back 0410; mobile/wireless interface devices 0500 and wired NFC reader 0600; and Internet-connected computer 0700.

The host server 0100 contains the Internet-based infrastructure at the heart of the security system, operated by an organizational entity responsible for creating and managing the centralized system architecture, including front end Website interface design and the back end database development required for organizing, issuing and managing unique Internet protocol (IP) addresses assigned to individually registered properties. The entity also maintains and manages all property and owner information records in aggregate. Client-supplied information will subsequently be used in applications involving property theft reporting, tracking and event mapping, in addition to projects involving database management statistical analysis.

On the physical side of the security system, the read-only target objects 0200 and 0300 are designed to be permanently affixed to or integrated into a property item, while the smartcard ID 0400/0410 is kept separate for quick account access and property owner verification. All three target objects are encoded with an identical unique Internet Protocol (IP) address that will hyperlink to a registrar/owner-managed property security status page when interrogated by internet-connected interface devices 0500 and/or 0600.

Manually entering the registrar/owner's smartcard ID registration number into the Internet browser domain name window of an internet-connected wireless device 0500 or computer 0700, or entering just the account number displayed on the QR code sticker 0300 on the host server's home page where indicated will also open the unique IP address security status page.

At the client user level, server processes are predominately automated, with auto-filled entries and form generation. Secure owner authentication entry on any property security status page grants access to editing, updating and managing capabilities related to contact and property information on any of the registered properties listed in the registrar's Master Account Directory. Most importantly, authentication access allows the registrar/owner to immediately launch “lost” or “stolen” security status announcements from any internet-connected location.

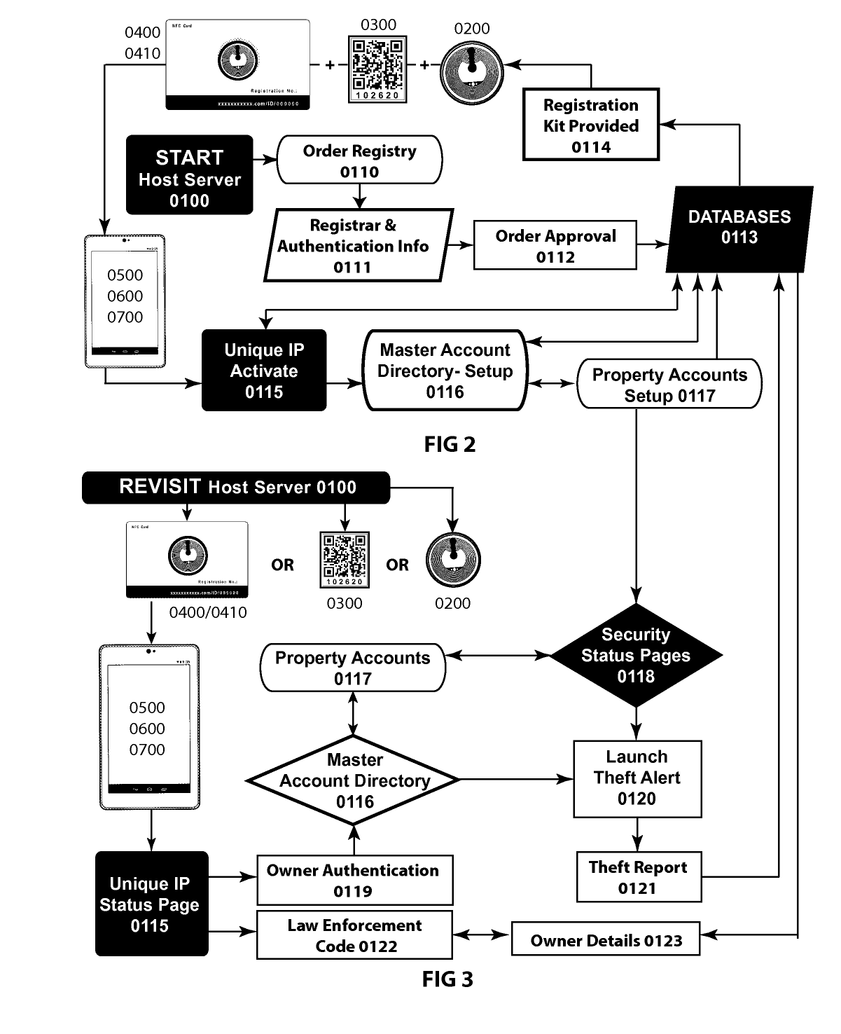

FIG. 2 is a flow chart diagramming the personal and business property registration process on the Host Server 0100, whereby a registrar begins by submitting personal information and shipping details, authentication metrics and number of properties to register 0110 before selecting a payment option. The present authentication model requires owner e-mail and owner-selected password, but alternative authentication methods arising from evolving technologies are also acceptable and adhere to the spirit of this invention.

Payment approval 0112 shifts registrar information from a “holding account” database 0111 to an “active account” in database 0113, generating an auto-filled Master Account Directory 0116 dedicated to said registrar. In addition to listing registrar personal information, the Master Directory serves as a portal page to individual Property Accounts 0117, each identified by the serial suffix number component of the Property Account's assigned unique IP address. Every Property Account contains an index menu with hyperlinks to owner and property management files and a security status activation page. All Master Account Directories are organized and managed under a parent directory on the host server 0100. Payment approval simultaneously involves providing full or partial physical registration kit(s) 0114 to the property registrar, depending upon whether the property is already hosting target objects. Each full kit contains the passive NFC tag 0200, a QR Code sticker 0300 and a smartcard ID 0400/0410 encoded with the identical unique IP address.

Upon receipt of property hosting target objects 0200 and/or 0300, or after securing these objects to a personal or business property in a device-accessible, tamper-resistant manner, the owner/registrar returns to the security system's host Web server to complete the registration process for each property now physically associated with an assigned unique IP address.

The registrar accesses their Master Directory by first employing the same methods the public and law agencies use to ascertain the security status and rightful owner of registered property. An internet-connected mobile, wireless or wired NFC-equipped device 0500 or reader 0600 is held over the hyperlink-encoded read-only NFC tag 0200, either integrated or affixed to the property object or laminated in the smartcard ID 0400/0410 until the property's unique IP address opens online. An alternative hyperlink method involves scanning the QR Code located as a property sticker 0300 or printed on the smartcard ID back side 0410 using a QR Code application on a mobile or wireless device 0500. Lastly, the property's security status page can be reached manually through the Internet browser of an internet-connected device 0500 or 0700, by either entering the smartcard ID's registration number into a domain name window, or the printed QR code number into a box as indicated on the host server's home page 0100.

The initial announcement appearing at each unique IP address 0115 is “Activate Account”, which is initiated by first entering the correct registrar-selected authentication metrics 0111. All accounts listed in a registrar's Master Account Directory 0116 are accessed using the same authentication metrics. Authentication approval opens the registrar's Master Directory 0116 setup, where changes can be made to auto-filled owner content and additional personal information can be added before hyperlinking to each Property Account 0117 setup page. The number of Property Accounts listed in the Master Directory indicates the number of registration kits ordered or registered properties obtained by the registrar. At this stage, the only information listed on each Property Account Page is the IP address account number and auto-filled registrar information.

Because the system ordering interface 0110 encourages purchasing multiple registration kits, including ones for family members sharing the registrar's surname, it is permitted to enter different first name, contact information and optional portrait for each Property Account 0117. The registrar/owner also enters all descriptive details of the property to which the IP address target objects 0200 and 0300 are integrated or affixed. This includes, but is not limited to, manufacturer's registration number, physical characteristics, age, value, brand and all other important descriptors relevant to the specific property, with optional download of property photos. The depth of information provided through the Property Account Setup is intended to broaden property search, sales and theft reporting capabilities.

The final step of each property registration process involves activating one of the following personal property security status page 0118 announcements: “Secure”, “Stolen”, “Lost” and “For Sale”, but not excluding other potential selections following the spirit of this invention. The newly activated security status announcement selection 0118 replaces the “Activate Account” 0115 page initially parked at the registered property's IP address.

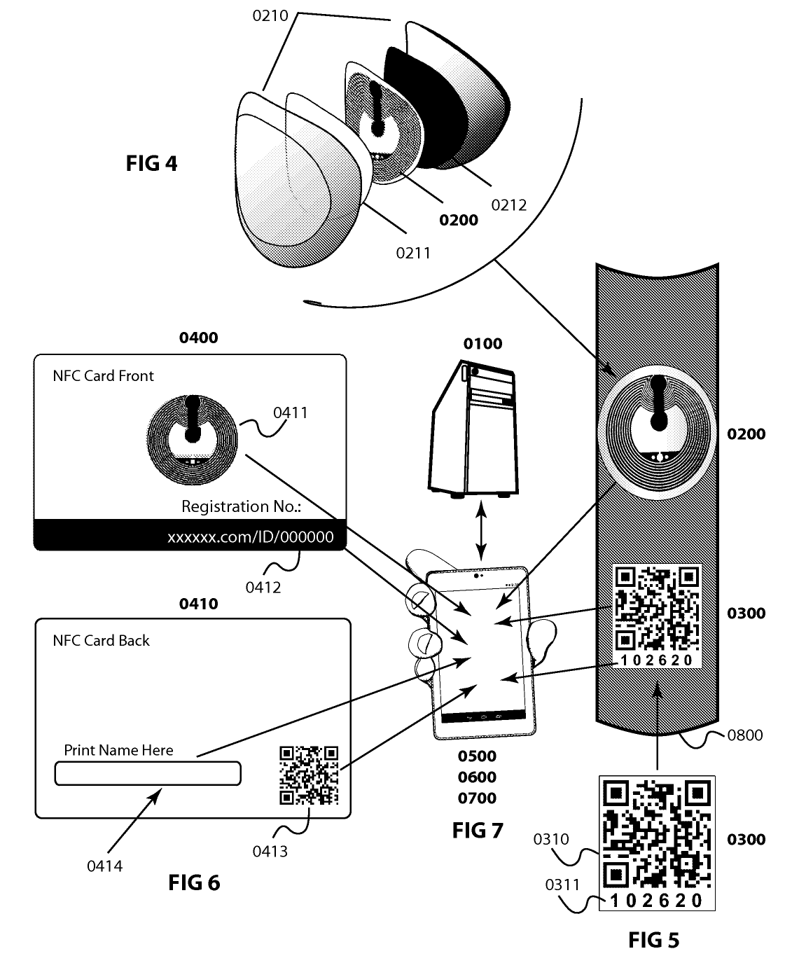

FIG. 3 is a flowchart illustrating subsequent visits by the owner to the newly registered personal or business property's Security Status Page by hyperlinking to its unique IP address through the NFC tag 0200 or QR code Sticker 0300 affixed to said property or through identically encoded NFC and QR code mediums on the smartcard ID 0400/0410 using the internet-connected interface devices 0500, 0600, and 0700, as previously described in FIG. 2 and described in greater detail in FIGS. 4, 5, and 6 below. The owner-activated security status page 0118 with owner name, contact number, city, state and country can now be viewed by any public interrogator with functional knowledge of the property security system on the internet browser of their Internet-connected interface device. A quick phone call to the owner can quickly report discovery of stolen or lost property or a theft in progress.

An authorization section of all security status pages provides for both owner authentication account access 0119 and law enforcement code access 0122. Registrar/owner authentication grants access to the registrar's Master Account Directory 0116, from which an immediate theft alert 0120 option is available when property is discovered stolen. Theft detail information collected in the process of launching the theft alert is forwarded as a theft report 0121 to a server database 0113 and delivered as a fixed format report with owner, property and theft details 0123 to law enforcement. The report details are also available to field officers who can view it after entering their department authorization code 0122 when interrogation of property target objects 0200 or 0300 determines a property is stolen. A similar report can also be made available for insurance purposes.

The registrar/owner also has the authority to edit or update selected information on the Master Account Directory 0116 and any Property Account 0117, including certain property description entries. Within each property account is also the option of launching a new property security status announcement 0118 to replace the property's current unique IP address security status page 0115, including an “Account Deactivated” announcement when the property is sold or otherwise disposed of Any property transfer requires re-registration with the server managing entity.

FIG. 4 is an exploded view of a sample passive (unpowered) Near Field Communication (NFC) RFID transponder tag 0200 and related components, one of three target objects provided to a registrar in their registration kit. The tamper-resistant NFC tag has or will be either affixed or integrated into a registered property in a visible, device-accessible location to act as a visual deterrent to thieves and provide secure, effective device interrogation. In this example, the NFC tag 0200 is encased in a tamper-resistant polycarbonate housing 0210, faced with a printed, fade resistant brand label 0211 and backed by a ferrite base layer 0212.

The NFC tag 0200 itself consists of a capacitor, antenna and microchip, onto which a unique IP address has been encoded and locked in read-only format using a dedicated NFC reader/writer. For the encoded IP address to function as a hyperlink, the NFC-equipped device's NFC application and Internet browser must be turned on and operational. Holding the 13.56 MHz reading device within 20 cm over the targeted tag powers-up the capacitor and activates the microchip to transmit its unique IP address back to the interrogating device using the NDEF data exchange format. This in turn open's the security status page of the property associated with the tag on the device's Internet browser for viewing.

Since the concern of this invention's property security system is NFC tag use and not its invention, this drawing is not intended to accurately convey exact physical dimensions, component layout, performance characteristics or materials used in tag construction, nor those of the tamper-resistant housing encasing it. NFC tag development is constantly improving, so tag and housing selection will vary according to security system applications, as determined by the type of property to which the tag is affixed or integrated into, transponder sensitivity, material composition and spatial confinements, among other factors.

This drawing does accurately depict the necessity of encasing the NFC tag within a tamper-resistant housing when the material or property to which it is bonded requires the tag be mounted externally for readability. Despite the NFC tag's advantage of not requiring line-of-sight readability, antenna reception will fail if the tag is completely enclosed in metal. The tag does continue to perform well when affixed externally to a metal surface, but only when the antenna is isolated by backing the tag with a ferrite base layer.

The tamper-resistant NFC tag housing 0210 in this illustration is polycarbonate, injected molded to conform to the cylindrical shape of a bicycle downtube 0800, but this is only one example of many housing designs contoured to specific internal or external target property surfaces. Housing shape and material choices and methods by which NFC tags are affixed will be dictated by the best theft-resistant solutions available. Only when the NFC tag can be hidden in an inaccessible nonmetallic area of personal or business property is the housing or ferrite layer unnecessary, but even then a visual indicator is required to reveal the existence and location of an NFC tag.

FIG. 5 shows the printed Quick Read (QR) matrix barcode sticker 0300, configured to hyperlink to the same unique IP address assigned the NFC tag 0200 and Smartcard ID 0400/0410 it accompanies in a property registration kit. The QR code sticker primarily serves as backup to the NFC tag, when an internet-connected interrogating device lacks NFC technology. Despite this sticker's outdoor durability and relative permanence, its reliance on line-of-sight readability can be compromised if the matrix barcode is accidentally scraped or intentionally vandalized. Property owners are instructed to place the sticker within proximity of the NFC tag, as shown on 0800 to signal its affiliation with the brand displayed on the NFC tag.

On the plus side of the technology, QR code applications (apps) are widely used and have been available for download to any mobile platform since 2010. QR code target sticker interrogation is initiated by opening up the QR code app on an internet-connected mobile device 0500 and aiming the device's camera at the QR Code 0310 until the hyperlink opens to the property's current Security Status Page.

An additional feature printed on the QR code sticker is the property's visible account number 0311, which can be compared to a property owner's smartcard ID registration number when Internet service is unavailable. This number can also be entered manually where indicated on the host server home page to open the property's Security Status Page.

FIG. 6 illustrates the registration kit's account-matching owner smartcard ID front 0400 and back 0410. The card is kept separate from target objects, to be deployed as proof of property ownership or to provide a quick link to a registrar/owner's Master Account Directory. The card can also be produced in virtual fog,', as photographic images of card front and back stored for presentation on a mobile device, along with an offline record of the registered property's security status page to compensate for the physical smartcard's hyperlinking attributes.

Every smartcard ID contains three account-matching features identical in function to property target object technologies, including the methods for accessing a property's security status page as described in FIG. 4 and FIG. 5. The smartcard features an NFC tag 0411 layered in its substrate, a printed QR code 0413 on the card's back side and the property's unique IP address registration number 0412 on the card's front side.

This printed alphanumeric registration number consists of a uniform prefix string designating the host server's URL plus a named accounts directory followed by the registered property's unique serial account number (e.g. xxxxxx.com/xx/00000 . . . ), which may or may not be embossed. The entire number 0412 can be entered manually into the domain name window of an Internet browser on an Internet-connected interface device to ascertain the security status of the registered property, or just the serial number can be entered where indicated on the host server home page to achieve the same results. Another smartcard verification feature is the signature strip 0414 located on the card's back side for the owner's printed full name, for comparison to the one listed on the property's security status page.

The smartcard ID can be used by its owner to automatically hyperlink to the card's encoded IP address for registering, managing, updating or deactivating a property account through the registrar's Master Account Directory, and to proffer to individuals or law enforcement for property owner online or on-sight verification, to expedite the return of lost or stolen property, and to legitimately excuse the forced removal of a broken lock or sale of registered property, among other scenarios.

FIG. 7 exhibits a representation of internet-connected wireless device transceivers 0500, wired NFC reader 0600 and computer Internet browser 0700, as interfaces between registration kit target objects NFC tag 0200 and QR code sticker 0300 or NFC smartcard ID 0400/0410 and the host server 0100, using connection methods described in FIG. 4 and FIG. 5.

1. A system and method for remotely registering, managing, viewing and verifying personal and business property security status accounts and owner-related information on a centralized network server using wireless or wired Internet-connected devices capable of interfacing between said server and account-matching target objects consisting of uniquely encoded Near Field Communication (NFC) tags and Quick Read (QR) codes and/or printed alphanumeric registration numbers, all permanently affixed, integrated and/or assigned to said properties.

2. Wherein each account in claim 1 is assigned a unique Internet Protocol (IP) address registration number corresponding to said property's online Security Status Page, which also provides registrar/owner access to the account's dedicated directory of property and owner information files.

3. Whereas registering and managing in claim 1 involves using secure authentication for authorized access to any account listed under a registrar's Master Account Directory to register properties, activate security status announcements, and manage related files.

4. Whereas viewing in claim 1 refers to public or law agency online viewing of Security Pages, each displaying property account number, owner name, contact and location information, and optional photo(s).

5. Wherein the server of claim 1 is hosted by an operating entity responsible for the design, development and management of system resources and owner/property accounts.

6. Wherein wireless devices in claim 1 are mobile phones, pads, readers or like-devices equipped with NFC tag reading hardware and software and/or a QR code scanning application, and wired device refers to a computer or computer-connected NFC tag reader.

7. Whereby the first interface method of claim 1 involves automatically hyperlinking to a property Security Page by interrogating read-only (locked) passive NFC property tag(s) with an NFC reading device.

8. Whereby the second interface method of claim 1 involves auto-linking to the Security Page by scanning the property's printed QR code sticker using a device containing an operating QR code reader application.

9. Whereby the third interface method of claim 1 for accessing a Security Page involves manually entering the property's alphanumeric IP address registration number into an active Internet browser.

10. A method of ensuring a registrar gains possession of the complete security system registration kit for each property, consisting of NFC tag(s) and QR Code(s) target objects and an account-matching cross-reference smartcard ID, featuring a read-only passive NFC Tag laminated in its substrate, a printed QR code and registration number IP address and a signature strip for penning the owner's printed name.

11. Whereby the smartcard of claim 10 is kept separate from property target objects and is used to access registrar/owner Property Account(s) or to offer as proof of property ownership.

12. Whereby cross-referencing in claim 10 involves either comparing online Security Page results by employing identical interrogation methods on both smartcard target features and property target objects or by visually comparing the account number printed on both smartcard and target object(s).

13. Wherein the smartcard in claim 10 is valid whether produced by owner/registrar in physical form or virtually, as photographic images of card front and back displayed on a mobile device.

14. A provision of the security status system whereby the owner/registrar activates the “Account Deactivated” security announcement when property is sold or discarded, since transfer of said property requires new owner re-registration of unique IP address account number.
